(19) United States
(12) Patent Application Publication
(10) Pub. No.: US 2010/0035090 A1
(43) Pub. Date: Feb. 11, 2010

(54) OFF-STATE DEGRADATION PREVENTION IN A FUEL CELL WITHOUT ON-STATE LOSSES USING SELF CONTROLLED ELEMENT

(75) Inventors: CLARK G. HOCHGRAF, Honeoye Falls, NY (US); Balasubramanian Lakshmanan, Pittsford, NY (US); Daniel I. Harris, Honeoye Falls, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/187,069

(22) Filed: Aug. 6, 2008

(51) Int. Cl. H01M 8/04; H01M 8/02

(52) U.S. Cl. 429/7; 429/24

(57) ABSTRACT

A fuel cell system that employs a technique for reducing MEA degradation during system shut-down that occurs as a result of the hydrogen and air being present in the fuel cell stack flow channels. The fuel cell system includes a non-linear load element, such as a positive temperature coefficient resistor, electrically coupled to each fuel cell in the fuel cell stack. The non-linear element operates such that it has high electrical conduction at low cell voltages and low electrical conduction at high cell voltages. During system shut-down, the voltage that is generated as a result of the hydrogen and air interaction in the fuel cells that creates a low cell voltage is drawn from the fuel cell and dissipated by the element. During system operation, the fuel cell potentials are relatively high and the resistance of the element goes up so that less current flows through the element, thus reducing electrical losses.

### BACKGROUND OF THE INVENTION

1. Field of the Invention

This invention relates generally to a system and method for reducing catalyst degradation in the MEAs of a fuel cell stack and, more particularly, to a system and method for reducing catalyst degradation in the MEAs of a fuel cell stack that includes electrically coupling a non-linear element to each fuel cell in the stack that provides a relatively high conduction of current at low cell voltages and a relatively low conduction of current at high cell voltages.

2. Discussion of the Related Art

Hydrogen can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with oxygen and electrons in the cathode to generate water. The electrons from the anode cannot pass through the electrolyte, and thus are directed through a load to perform work before flowing to the cathode.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired voltage and power. For the automotive fuel cell stack mentioned above, the stack may include two hundred or more fuel cells. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

Typically at system shut-down, hydrogen that may be remaining in the anode flow channels may be purged using cathode air or consumed, and the stack is sealed. However, hydrogen gas has a tendency to leak through seals and valves in the system, which causes some hydrogen gas to flow into the fuel cell stack when the system is shut-down. This hydrogen is not uniformly distributed within the flow channels and has the effect of creating localized voltage potentials within the stack where hydrogen and air interact with the catalyst at those locations. The localized voltage potentials cause a corrosion reaction in the catalyst layer, thus reducing the life of the MEAs and the fuel cell stack. The corrosion of the catalyst layer increases exponentially with the voltage potential across the cell. Therefore, it is essential to suppress the voltage across the cell during this off-condition.

It is known in the art to provide a shorting resistive load across each fuel cell in the fuel cell stack that allows current that is generated as a result of the oxygen and hydrogen gas interaction in the fuel cell during system shut-down to be conducted out of the fuel cell and passed through the external resistor, thereby suppressing the voltage and, thus preventing the catalyst layer from being damaged. However, providing a shorting resistor across each fuel cell in the fuel cell stack for this purpose during system shut-down provides significant electrical losses during operation of the fuel cell stack as a result of the current being drawn from the fuel cell stack through the resistor.

### SUMMARY OF THE INVENTION

In accordance with the teachings of the present invention, a fuel cell system is disclosed that employs a technique for reducing or significantly eliminating MEA degradation during system shut-down that occurs as a result of the hydrogen and air being present in the fuel cell stack flow channels. The fuel cell system includes a non-linear load element electrically coupled to each fuel cell in the fuel cell stack. The non-linear element operates such that it has high electrical conduction at low cell voltages and low electrical conduction at high cell voltages. During system shut-down, when there is no active flow of reactants, the voltage that is generated as a result of the hydrogen and air interaction in the fuel cells is suppressed by the element. When high levels and flows of hydrogen and oxygen reactants are present, such as during normal operation, the element's ability to conduct current is insufficient to suppress voltage. During system operation, the fuel cell potentials are relatively high and the resistance of the element goes up so that less current flows through the element, thus reducing electrical losses. In one non-limiting embodiment, the non-linear element is a positive temperature coefficient (PTC) resistor that provides the change in resistance as the cell voltage changes and also provides a desirable change in resistance in response to temperature changes.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system;

FIG. 2 is an illustration of a fuel cell stack including a non-linear resistive element coupled to each fuel cell in the stack that draws current from the fuel cells at low voltages; and

FIG. 3 is a graph with cell voltage on the horizontal axis and cell shorting current on the vertical axis showing the operation of the non-linear elements electrically coupled to the fuel cells in the stack shown in FIG. 2 for two different temperatures.

### DETAILED DESCRIPTION OF THE EMBODIMENTS

The following discussion of the embodiments of the invention directed to a technique for reducing or eliminating MEA degradation during fuel cell system shut-down is merely exemplary in nature, and is in no way intended to limit the invention or its applications or uses.

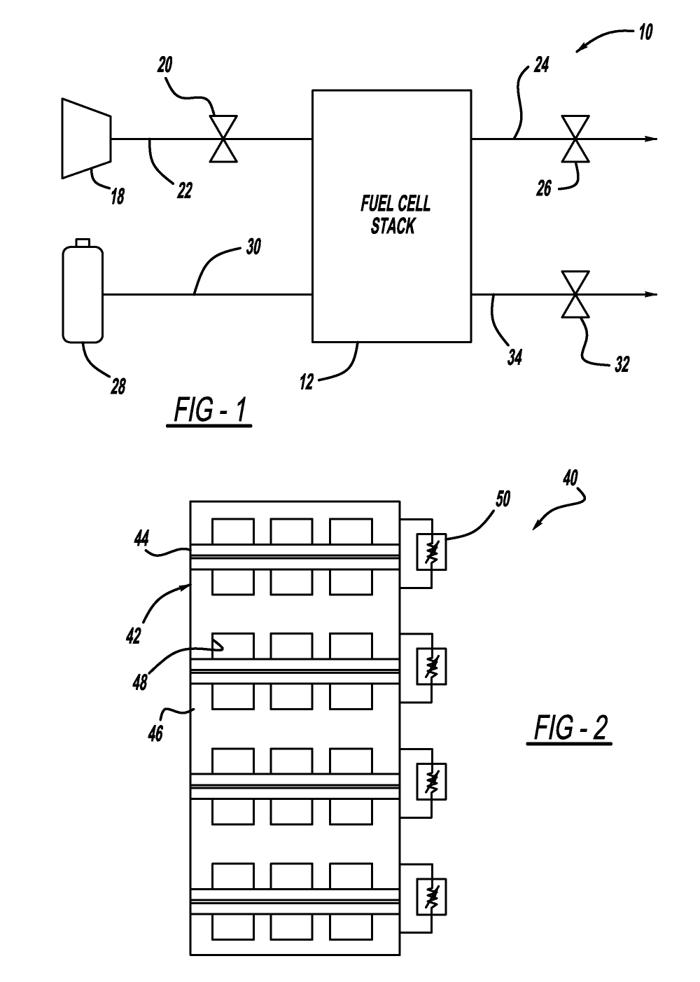

FIG. 1 is a schematic block diagram of a fuel cell system 10 including a fuel cell stack 12. A compressor 18 provides cathode inlet air through a cathode inlet valve 20 and a cathode inlet line 22 to the fuel cell stack 12, and cathode exhaust gas is output from the fuel cell stack 12 on a cathode exhaust gas line 24 through a cathode outlet valve 26. Hydrogen from a hydrogen source 28 is provided to the anode side of the fuel cell stack 12 on an anode inlet line 30. Anode exhaust gas is output from the fuel cell stack 12 through an anode outlet valve 32 on outlet line 34.

FIG. 2 is an illustration of a fuel cell stack 40 that includes a plurality of fuel cells 42 each having an MEA 44. Bipolar flow plates 46 including flow channels 48 are provided between the MEAs 44 in a configuration that is well understood to those skilled in the art. As discussed above, it is desirable to provide some sort of technique to reduce carbon corrosion during system shut-down. According to one embodiment of the present invention, a non-linear resistive element 50 is electrically coupled across each fuel cell 42 to provide a conductive path for current provided as a result of a voltage potential being generated when hydrogen and air react with the catalyst in the fuel cells 42, as discussed above. Particularly, when a voltage potential is generated within the fuel cell 42, the current that is produced will be conducted by the element 50 effectively suppressing the voltage so that the voltage potential does not cause corrosion of the catalyst layer, which causes degradation effects.

Because the element 50 is a non-linear element, its resistive properties will change in response to changes in voltage potential. Particularly, during system shut-down when the concentrations of hydrogen and oxygen are low, the hydrogen/air interaction produces low voltage potentials in the fuel cells 42, for example 0.1 V, the resistance of the element 50 is also low, which allows current to propagate through the element 50. As the voltage of the fuel cell 42 increases with high concentrations and flows of hydrogen and oxygen during normal system operation, the resistance of the element 50 also increases, which reduces its ability to conduct current. The current will be available to flow to the normal output contacts of the stack 40 to drive the vehicle or other system loads. Thus, when it is desirable to have current flow through the element 50 from the fuel cells 42 at system shut-down, the resistance of the element 50 is low, and when it is desirable to prevent current flow through the element 50 when the system 10 is operating, the resistance of the element 50 is high, thus reducing electrical losses during system operation.

In one embodiment, the non-linear element 50 is a positive temperature coefficient (PTC) resistor, known to those skilled in the art. The resistance of a PTC resistor increases in a non-linear manner as the voltage of the fuel cell 42 increases. Also, as the temperature of the fuel cell stack 40 increases to its operating temperature, the resistance of the PTC resistor also increases, thus further increasing the desired effect limiting electrical losses.

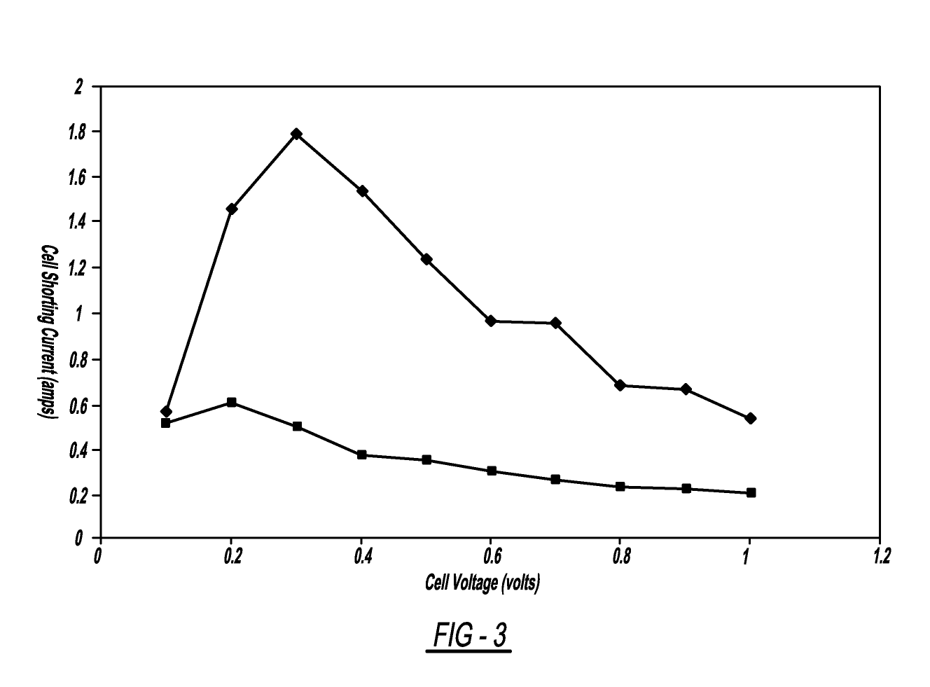

FIG. 3 is a graph with cell voltage on the horizontal axis and cell shorting current on the vertical axis showing the above described effect. The top graph line is for a stack temperature of 25° C. and the bottom graph line is for a stack temperature of 70° C. As is apparent, as the cell voltage goes up, the cell shorting current also goes up until the cell voltage reaches some value depending on the characteristics of the element, at which time the cell shorting current goes down. The reduction of current flow through the PTC resistor as a result of increased resistance is more dramatic at higher temperatures. Therefore, not only does the PTC resistor provide benefits for allowing current flow from the fuel cell 42 at low cell voltages when the system is shut-down and providing a relatively low shorting current when the cell voltage is relatively high, such as during system operation, the PTC resistor also provides a desirable response to temperature where the current flow is higher at lower temperatures typically seen during a long off-state after shut-down.

According to another embodiment, the non-linear element 50 includes a transistor circuit that is switched on and off depending on the cell voltage. When the cell voltage is below some predetermined voltage that is greater than the voltage potential produced by the hydrogen/air interaction when the system is shut-down, the transistor in the circuit conducts so that the current is allowed to flow to some load within the circuit, such as a resistor or the transistors on resistance. When the cell voltage increases above the predetermined voltage during system operation, the transistor switches off, providing an open circuit that does not conduct current. Thus, during system operation, the elements 50 do not provide a load on the stack 40 that would provide significant losses.

Examples of circuits that provide this operation include, but are not limited to, a reed relay circuit, a semiconductor circuit including a zero threshold MOSFET transistor, a semiconductor circuit with internally boosted voltages and a bimetallic switching contact circuit. The reed relay in the reed relay circuit would be closed when the voltage potential of the fuel cell is below the predetermined voltage and would be opened when the voltage potential of the fuel cell is above the predetermined voltage. The bimetallic switching contact circuit would include a bi-metallic switch where the two metals have different coefficients of temperature so that one would expand more than the other in response to heat. This would cause the bi-metallic switch to open as the temperature of the fuel cell increased that could be designed to correspond with the temperature associated with the operation of the fuel cell. The bimetallic switch can also be configured to open based on its own internal heating due to conduction of current. When the bimetallic switch current is high, i.e., high cell voltage, the switch opens. When the fuel cell stack is relatively cold during system shut-down, the bimetallic switch would be closed.

The non-linear elements 50 can be external to the stack 40 or can be integrated within the stack 40 in the various plates and other stack structures. For example, the element 50 can be a component in a cell plate, a component in fuel cell gas seals or electrical isolation, a feature of the fuel cell proton conduction layer, a feature of shims or other supporting layers in the MEA, etc.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is Claimed is:

1. A fuel cell system comprising:
a fuel cell; and
a non-linear element electrically coupled to the fuel cell, said non-linear element providing a resistive load that provides greater current conduction through the element when the voltage potential of the fuel cell is below a certain voltage potential and provides less current flow through the element when the voltage potential of the fuel cell is above the certain voltage potential.

2. The system according to claim 1 wherein the non-linear element includes a positive temperature coefficient resistor whose resistance increases as the voltage potential of the fuel cell increases.

3. The system according to claim 2 wherein the resistance of the positive temperature coefficient resistor also increases as the temperature of the fuel cell increases.

4. The system according to claim 1 wherein the non-linear element includes a transistor circuit including a transistor that conducts when the voltage potential of the fuel cell is less than the certain voltage potential and does not conduct when the voltage potential of the fuel cell is greater than the certain voltage potential.

5. The system according to claim 4 wherein the transistor is a zero threshold MOSFET transistor.

6. The system according to claim 1 wherein the non-linear element includes a reed relay that is closed when the voltage potential of the fuel cell is below the certain voltage potential and is opened when the voltage potential of the fuel cell increases above the certain voltage potential.

7. The system according to claim 1 wherein the non-linear element includes bi-metallic switching contacts that open when the temperature of the fuel cell increases above a predetermined temperature.

8. The system according to claim 1 wherein the non-linear element is an integral part of the fuel cell.

9. The system according to claim 8 wherein the non-linear element is part of a cell plate.

10. The system according to claim 8 wherein the non-linear element is part of a fuel cell proton conduction layer.

11. The system according to claim 8 wherein the non-linear element is part of a shim or supporting layer of an MEA of the fuel cell.

12. The system according to claim 1 wherein the certain voltage potential is greater than a voltage potential of the fuel cell that would occur when the fuel cell system is shut down and is less than a voltage potential of the fuel cell when the fuel cell is operating normally when the fuel cell system is operating.

13. A fuel cell system comprising:
a fuel cell; and
a positive temperature coefficient resistor electrically coupled to the fuel cell to provide a resistive load, wherein the resistance of the positive temperature coefficient resistor increases as the voltage potential of the fuel cell increases so that the resistor provides less electrical conduction as the voltage potential increases.

14. The system according to claim 13 wherein the resistance of the positive temperature coefficient resistor also increases as the temperature of the fuel cell increases.

15. The system according to claim 13 wherein the positive temperature coefficient resistor is an integral part of the fuel cell.

16. The system according to claim 13 wherein the positive temperature coefficient resistor is part of a cell plate.

17. A fuel cell system comprising:
a fuel cell; and
a transistor circuit electrically coupled to the fuel cell, said transistor circuit including a transistor that conducts when the voltage potential of the fuel cell is less than a certain voltage potential and does not conduct when the voltage potential of the fuel cell is greater than the certain voltage potential.

18. The system according to claim 17 wherein the transistor is a zero threshold MOSFET transistor.

19. The system according to claim 17 wherein the transistor circuit is an integral part of the fuel cell.

20. The system according to claim 17 wherein the certain voltage potential is greater than a voltage potential of the fuel cell that would occur when the fuel cell system is shut down and is less than a voltage potential of the fuel cell when the fuel cell is operating normally when the fuel cell system is operating.
